(19) United States
(12) Patent Application Publication
(10) Pub. No.: US 2005/0246341 A1
(43) Pub. Date: Nov. 3, 2005

(54) Method for supervising the publication of items in published media and for preparing automated proof of publications

(76) Inventors: Jean-Luc Vuattoux, Le Lyaud (FR); Didier Durand, Jougne (FR); Jean-Luc Chatton, Bretigny (CH); Olivier Despont, Marsens (CH)

Correspondence Address: Blank Rome LLP, 600 New Hampshire Ave., N.W., Washington, DC, 20037, US

(21) Appl. No.: 11/138,891

(22) Filed: May 27, 2005

Related U.S. Application Data
(63) Continuation of application No. PCT/EP03/13518, filed on Dec. 1, 2003.

(30) Foreign Application Priority Data
Nov. 29, 2002 (EP) EP02026652.4

(51) Int. Cl. G06F 7/00

(52) U.S. Cl. 707/9

(57) ABSTRACT

A method for preparing automated proof of publications and for supervising the publication of items in printed media, said method comprising: preparing a database including specifications for a plurality of items to publish, publishing said items on printed media using said specifications, scanning printed media pages or capturing an electronic file from a pre-press system including the published items, automatically extracting from the digitized pages identifying metadata characterizing said published items, using said identifying metadata to retrieve from a database the address to which said proof of publication should be sent, performing a quality control for controlling the quality of said published item by confronting the published item with said specifications, sending a proof of publication including at least the portion of said page including said published item to said address.

The invention concerns a method for automatically preparing and sending proof of publications, as well as a method for supervising the publication of items in printed media, such as dailies, magazines, letters, bulletins, directories, etc. The invention also concerns a method for performing a quality control for controlling the quality of items published in printed media.

Publishers and printers that publish advertisements and announcements in printed media must provide their clients, i.e. the advertisers, partners or intermediaries, with a “proof of publication” (sometimes called a tear sheet) of their advertisements or announcements or other published matter (article, etc. . . . ). The proof of publication process allows the advertising customer or partner to control the quality of the item printed in order to ensure that it has been published in accordance with the original specifications in the publication order. It also provides to the advertising customers or partners an objective and preferably quantified way, using various numeric measures, for checking that the publication order actually ran, and that it ran according to these specifications. Differences between the specifications of the publication order placed by the customer and the actual publication can result in changes to invoices (discounts), free reprints or other settlement procedures.

In the newspaper industry, the publishers commonly provide “tear sheets” to various recipients such as the advertising customers, their partners or intermediaries, the content syndicate, etc. A tear sheet is a sheet separated from a printed media and sent to the customer to prove correct insertion of the order. The tear sheets are generally prepared manually by clipping or tearing the printed items from the publications. Those tear sheets are most often combined with an invoice and mailed to the recipients. If the advertising customer or partner detects a printing problem, he has to contact the publisher and ask for the problem to be solved or redressed.

The preparation of the tear sheets, the quality control and the settlement process are most of the time manual processes. As such, they are very costly, error-prone and human resource intensive. Consequently, tear sheets that are considered a free must by customers or partners greatly influence the financial operating margins of publishers who are looking forward to implementing automatic and technical solutions to this problem.

Electronic tear sheets are already known which are sent by electronic means, for example by email, to the recipients. In commonly known systems, the electronic tear sheet is generated from an electronic pre-press image before the publication. The image file is usually in a format delivered by a conventional page processing software, such as for example Quark XPress, Adobe InDesign or Adobe PDF (all registrated Trademarks). Publishers usually convert pre-press files received from the customers into raw image files, called pre-press plate files, directly used for producing the printing plates.

Electronic tear-sheets produced with this process do not deliver a proof of quality of the publication but only an electronic proof that the publication actually ran, or at least that the file has been received by the publisher. Quality problems occurring before, during and after the printing stage are not reflected by those pre-print tear sheets. More specifically, all errors that may occur during the conversion of the pre-press image into pre-press plates or pre-press plate files, or during the actual printing from the pre-press plate files, cannot be detected from those tear sheets, which are therefore unsatisfactory to most customers. Moreover, this process is still time-consuming for the publisher who has to clip the printed items from the printed media, generally after human visual recognition, and match those items with the corresponding advertising orders in order to retrieve the addresses of the advertising customers to which the tear sheets should be sent. Comparing the metadata of the published advertising item with the specifications of the publication order is still realized manually. Furthermore, the image delivered to the advertising customer contains only the published item, so that this process does not allow the advertising customer to see other items surrounding his published item.

A process which involves scanning pages of the printed media and then faxing a reduced-size copy of the scanned image has also been suggested in the prior art. The main goal of this solution is to reduce the postage costs incurred to deliver the tear sheet to the interested recipients. However, the quality of the black and white faxed, size-reduced image is not sufficient for controlling the printing quality of the printed item according to the high-quality standards of the printing industry. Furthermore, the identification, from the scanned page of a printed media, of the recipients to which the tear sheet should be transmitted is a difficult operation which is performed manually.

An object of the invention is to provide an improved automated proof of publication method, and an improved method for controlling the quality control of items published in printed media

Another object of the present invention is to provide a method for minimizing the costs and maximizing the efficiency of the process for controlling the publication and measuring the quality of publication (quantified by various measures) of items published in printed media.

Another object is to provide a method and system that reduce the load of the computing systems used from preparing the proof of publications, for detecting the quality of the publication, for computing prices or discounts, and for processing this information on the customer side.

Another object is to provide a method and system with which more quality problems can be detected, in a more uniform, objective and systematic way.

Another object of the invention is to develop new value-added services from the collected data.

In accordance with one embodiment of the present invention, those aims are reached with a method for preparing automated proof of publications, said method comprising:
retrieving an electronic file corresponding to the full printed media pages including the published items,
automatically extracting and deriving from said electronic file identifying metadata characterizing said published items,
using said identifying metadata for automatically retrieving from a database the address of the recipient to which said proof of publication should be sent,
sending a proof of publication including at least the portion of said page including said published item to said recipient.

According to another aspect of the invention, a logical link is automatically established between identifying metadata extracted from the printed item and specifications of the corresponding publication order in a database of publication orders. Once this link has been established, other data and specifications can be retrieved from the database for improving the proof of publication process and for assisting in the quality control process.

According to another aspect of the invention, the electronic file is retrieved by scanning the printed items. In another embodiment, the electronic files comprise at least one digital image of a pre-press plate directly used by the publisher on its presses for printing the published item.

According to another aspect of the invention, a quality control process is automatically performed by confronting the item in said electronic file with the specifications corresponding to the same item in the database of orders. The quality control process preferably generates a quality control report that can be sent, preferably together with the proof of publication, to the requesting recipients. The addresses of the recipients to which the proof of publication and quality control report are sent are preferably electronic addresses such as email addresses, but could also be postal addresses, fax numbers, etc. depending on the preferences of each recipient. Alternatively, the addresses could also be logical or memory addresses, for example the URL (Uniform Resource Locator) of a web server to which the recipients have access and into which said proof of publication and an accompanying quality control report are stored in digital form for subsequent access.

In a preferred embodiment, the identifying metadata retrieved from the published item include a unique identifier, for example an identification number or code, unequivocally designating this published item in the database of orders.

In a preferred embodiment of the invention, some unequivocally identifying metadata are embedded in a digital mark invisible to the human eye but that could be decoded from the digital image of the page featuring the advertisement. The mark could be for example a watermark embedded in the printed item.

In another embodiment, an identifier is embedded in a mark, for example a barcode, visibly printed on or near the published item.

In another embodiment, the identifying metadata include one or several less unique recognized or measured identifiers that, in combination, can be used for identifying, or helping in the identification of, each printed (scanned or pre-press) item. Those less unique identifiers can include the position and size of the published item in the printed media, or the number of colors in the published item, or the list of dominant colors. Text and graphical content, such as the title of the digitized printed media, the page number, the section of the printed media to which the page belongs and/or the publication date, are other examples of metadata which can be retrieved using for example an optical character recognition process, or directly extracted from the electronic files used for generating the printed media pages. In an embodiment, the text content is indexed and categorized in order to correspond to predefined categories in the publication order database. This allows for a reduction of database sections to be searched for matching orders.

In another embodiment, at least some identifying metadata, including an identification of the printed media, such as the title, a publication date, a section number, a section name, type or designation, a page number, etc., could be manually introduced by an operator during the process of acquiring (scanning or importing pre-press files) of the printed media. A-priori known reference layouts (frame structure, colors, titles, fonts, graphical elements) of the printed media are preferably used for assisting in the process of segmenting the pages to discover the items to be controlled and retrieving the identifying metadata.

According to another aspect of the invention, the aims of the invention are also reached with a method for supervising the publication of items in printed media, said method comprising:
preparing a database including specifications for a plurality of items to publish,
publishing said items on printed media using said specifications,
retrieving an electronic file corresponding to the printed media pages including the published items,
confronting the item in said electronic file with the specifications of said item in said database for controlling the quality of the published item.

In an embodiment, a settlement method, for example a discount on the price billed for the published item, a free reprint, etc., is automatically computed and applied when quality problems are detected.

In an embodiment, the metadata retrieved for the quality control comprise the size and/or position of the published item in the printed media or in the pre-press full-page image. This size and/or position are then compared with the size and/or position requested in the specifications in the database of orders.

In another embodiment, the quality control also comprises a step of automatically comparing the actual publication date with the publication date requested in the specifications in the database of orders.

The quality control can also comprise a step of automatically extracting the text content and/or the graphic content from the published item, and automatically comparing the text content and/or graphic content with the specifications in the database of orders.

In another embodiment, the quality control also comprises a step of automatically verifying the colors of the published item and comparing them with the corresponding specifications in the database of orders. Color quality controls are efficient and deliver most of their value in the analysis of scanned printed items but can contribute also to color quality control in imported pre-press files.

In yet another embodiment, the quality control also comprises a step of automatically computing the difference between the retrieved image and a reference image included in or composed from the specifications in the database of orders, whereas adaptations may be performed in order to take into account acceptable “physical” biases introduced by the printing process.

In yet another embodiment, the size or position of the published item in the printed media and the publication date are transmitted by the publisher to the entity in charge of the quality and publication control at the same time as the pre-press full-page image. These sizes, positions, colors and publication dates are then automatically compared with the size, position, colors and publication date specified in the database of orders.

The methods and systems of the invention also allow new value-added services to be realized based on the specifications, on the extracted metadata and on the content of the published items.

A first example of services is based on statistics of publications useful to publishers, advertisers and their intermediaries and partners. Those statistical analyses are based on the content (for example, analysis of advertisement campaigns by products, companies, etc. or analysis of competitors to provide a “business intelligence” service), on the container (for example, analysis of the advertisement formats used and their frequency, of types of media preferred, etc.), on the quality of content (for example, analysis of quality drifts or improvements in printed media, printing centers or publishers, etc.) and on the budget (for example, evaluating the advertising budget of a given company or from a publisher's standpoint, evaluating the advertising revenues of competitors).

A second example of services is based on the reuse of the printed media content. The analysis and indexing of the printed media items allow to provide, for example, clipping services by Web, email or other electronic means and intelligent search services by words or phrases of current or previously published news or articles or advertisements from different printed media. For example, this would allow retrieving from the database all the advertisements about a specific product or corresponding to and matching certain wishes or all news about a topic.

The invention will be better understood with the help of the description of a specific embodiment illustrated by the figures in which:

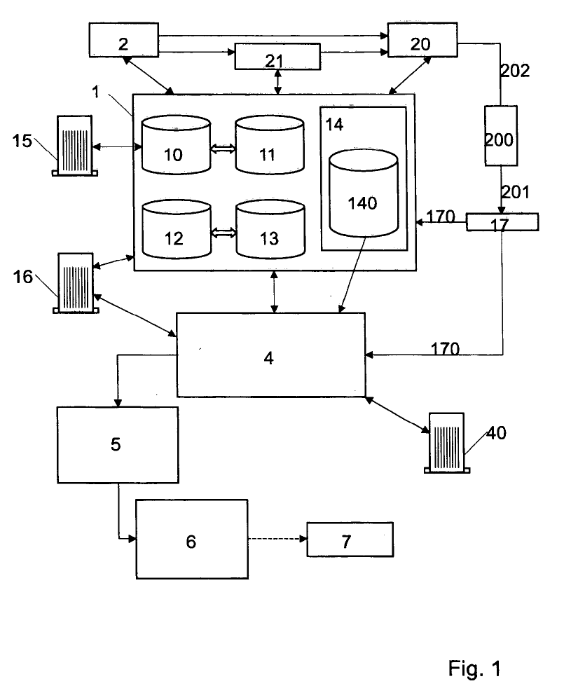

FIG. 1 shows a diagram of a system according to the invention for publishing items in printed media and supervising the quality.

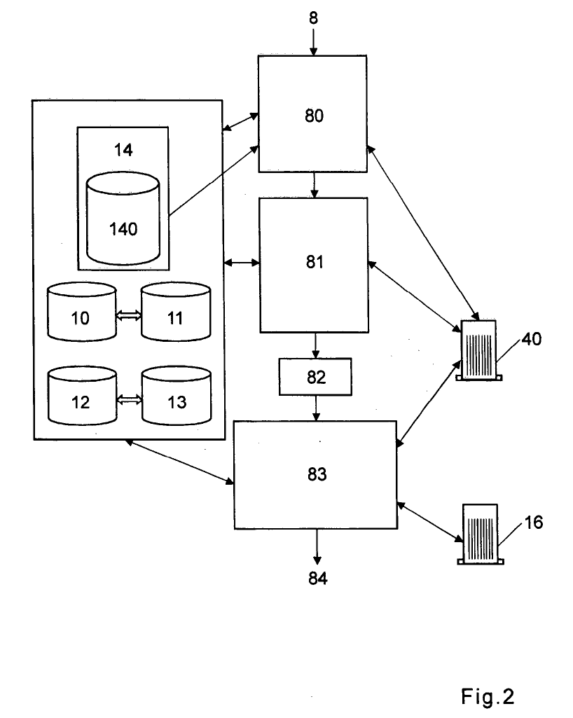

FIG. 2 shows a diagram of a system for extracting identifying metadata from items published in printed media.

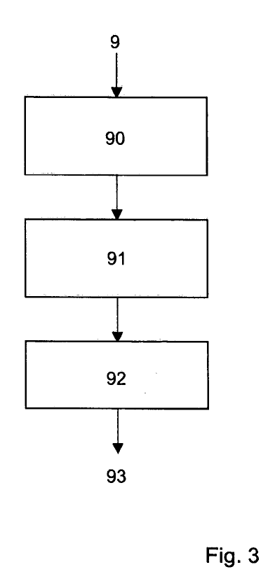

FIG. 3 is a flow-chart illustrating some steps of the quality control process.

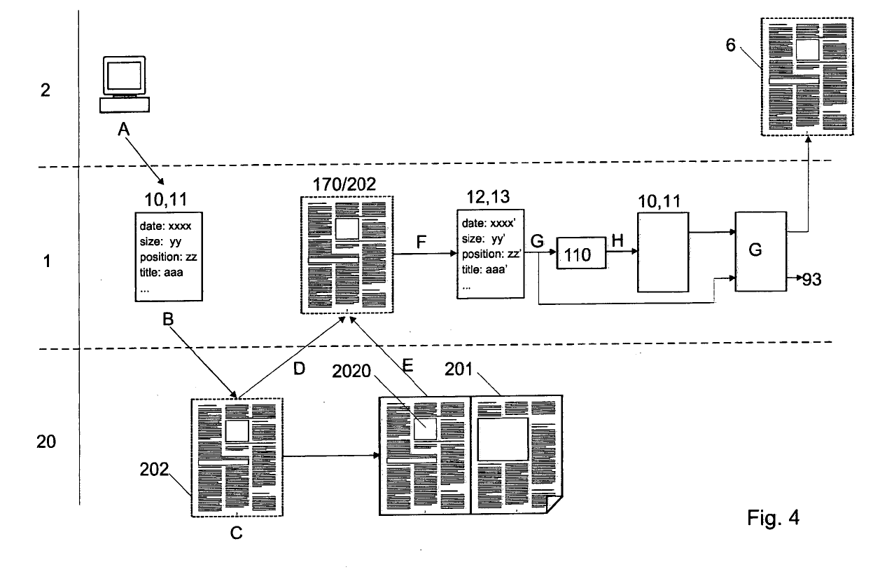

FIG. 4 is a bloc schema of the tear sheet generation and quality control methods of the invention.

In the description and in the claims, when we use the term “item”, we mean all types of content (advertising, editorial or literary) found in a printed media and subject to publication and quality controls. Examples of items include advertisements, articles, pictures, graphical elements, book chapters, and so on.

When we talk about advertisement, we mean classified advertisements and display advertisements. Classified advertisements are usually stored in raw text, raw text with a layout directive and/or one or more logos, or as a picture, while most display advertisements are handled in image format (photograph or picture with formatted text and/or logos). In some cases, notably when the specifications do not include a complete image, the image actually published must be composed from specifications.

When we talk about printed media, we mean for example daily newspapers, magazines, leaflets, directories, prospects, company reports, any kind of books, and so on.

When we talk about customer, advertiser or advertising customer, we mean the entity who actually orders the publication of the item, and who is likely to pay for this publication.

The term “publication orders” used in the rest of the document designates orders of publication for one or more items. Those orders are sent by an advertiser, a partner of an advertiser, an intermediary or any other ordering entity or controlling entity of to a publishing house. The publication order contains specifications relating to the items to publish.

When we talk about specifications, we mean all types of metadata predefined by the advertising customer or by its partner, the requesting entity for defining the content, aspect and publication conditions of the item to publish. These specifications include for example:
Details of the entity ordering or requesting the publication, for example an advertiser, an advertising agency, an intermediary, a publisher, a legal authority, etc. The details can include the name of the entity, the postal and electronic addresses, the phone and fax numbers, billing data, etc.
Details of one or several recipients to which proof of publication and/or quality control reports should be sent. Similarly, the details can include the name of the entity, the postal and electronic addresses, the phone and fax numbers, billing and reimbursement data, etc.
Names or other designations of the selected printed media in which each item should be published.
Position of the item in the selected printed media (page, section, column, topological position on the page).
Desired dates of publication, possibly depending on the media.
Theoretical size of the item expressed for example in number of columns and/or lines, and/or in vertical millimeters, and/or with any other valid size measurement metric, specifically or not for each selected printed media.
Text and/or graphic content of the item. In a preferred embodiment, the specifications include a reference image in an electronic format of each item to print. This reference image can be for example the original picture, or a digital proof simulating the paper shade of printed media, or the scanned version of a printed proof provided by the customer.
Layout directives (textual content characteristics: position, size, fonts, colors, styles used; graphical content characteristics: position, size, number and details of colors, resolution, etc.).
Included logos or pictures, when needed (not permanently stored by the publisher).
Optional supplementary specifications, preferably including a unique identifier unequivocally identifying each item to publish, that may be added to each order and/or processed from otherwise available specifications. Those supplementary specifications may include manually entered or automatically indexed data, such as for example category of the advertised product, brand, price, type of advertisement and other specifications derivable from the content of the advertisement.
Categorization information; indexing information.
etc.

At least a part of the metadata is retrieved from the published item.

When we talk about pre-press process, we mean all the processes between the receiving of the specifications of isolated items and the composition of the full-page images of the printed media used for generating the printing plates.

When we talk about proof of publication, or tear-sheet, we usually mean an electronic image file, or a pointer to an electronic image file, of the advertised item or of the page featuring the advertised item.

A preferred embodiment for generating tear sheets and for controlling the quality of publications is illustrated with FIG. 1. During step A, an advertising customer 2 sends a publication order to a system 1 administrated by the entity in charge of the quality control process. The publication order may be generated with an online or offline software, over a Web site, or may include letters or facsimile letters sent to the system 1. It includes specifications defining the item to publish. Additional specifications may be defined by the system 1.

During step B, the system 1 receives the publication order and stores the corresponding specifications in a database of orders 10, 11. In this example, the text and graphical content of the specifications are stored in a first database 10 whereas other publication details are stored in a separated database 11; the one skilled in the art will understand that other database organizations are possible in the frame of the invention.

During step C, the specifications 10, 11 are sent to the publisher 20, i.e. to the entity in charge of the actual publication of the ordered item. The publisher 20 performs all the pre-press processes necessary for converting the specifications 10, 11 into pre-press plate files 202, and for printing the printed media 201 including the published item 2020 and corresponding to the file 202. Alternatively, some steps of the pre-press process are performed by the system 1.

In a preferred embodiment, the pre-press full-page plate files 202 are sent to the system 1 (step D).

The printed media 201 is preferably scanned, preferably by the entity administrating the system 1, in order to retrieve a digitized image 170 corresponding to the published page containing the published item 2020 (step E). An image analysis processing and/or OCR conversion may be performed during this scanning process.

Metadata are retrieved during step F from the imported and/or from the digitized image 202 respectively 170 of the printed page. The metadata correspond to at least some of the specifications 10, 11 of the corresponding item in the database of orders. In the illustrated embodiment, the extracted text and/or graphical content are stored in a first database 12 whereas the additional metadata are stored in another relational database 13; other architectures are possible within the frame of the invention.

During step G, identifying metadata 110 are extracted from the set of metadata retrieved during the previous step. The identifying metadata preferably allow identifying exactly the advertisement order in the database of orders 10, 11 that corresponds to the published item from which the current set of metadata has been retrieved. The identifying metadata may include one unique identifier or a unique combination of metadata.

During step H, the identifying metadata 110 extracted during the previous step are used for retrieving the matching initial specifications in the database of orders 10, 11.

During step G, the initial specifications retrieved during the step H are compared with the corresponding extracted metadata. A control of the quality 5 of the pre-press processes and of the publication itself is based on the comparison. A tear sheet 6 may be generated during this process, including preferably an image of the printed page that features the published item and eventually an extracted image of the published item itself, a quality control report, a bill and/or a credit note computed by a billing system 7 and including possible discounts based on the result of the quality control. Other quality control reports and statistics 93 may be computed based on this quality control and on the metadata of one or several published items.

In a preferred embodiment, the method of the invention is performed with the system illustrated on FIG. 1. A system 1 including a database of publication orders 10, 11 is provided for central storage of publication orders. The system 1 is preferably centrally run by a publisher 20 or by an entity having access to as many publication orders as possible for different printed media of different publishers. In another embodiment, the system 1 is run by an entity in charge of the quality control process. The system 1 may also include distributed databases physically stored in different places and managed by different entities.

Each publication order corresponds to one or several items, for example an advertisement, which should be published one or several times, at the same or at different dates, in one or several printed media. Each publication order contains or is related to a text and graphical content 10 and to other specifications (metadata) 11 relating to those items.

Each publication order is further related to recipients 2, 20, 21, for example advertisers 2, publishers 20 or advertising agencies (intermediary) 21, to which the proof of publication, the quality control report and/or the bill or credit note computed by the billing system 7 should be sent. The billing and postal or electronic addresses of the recipients have been registered and are available in the database.

The specifications of publication orders are then sent either directly or via an intermediary 21 to the publisher 20 of the printed media 201 for publication of the item according to the specifications in the database 11. In another embodiment, some or all specifications are stored in the central database after the publication, but before the quality control.

After publication (process 200), an electronic file 170 or 202 corresponding to the printed media pages 201 including the published items is retrieved by the entity in charge of the publication and/or in charge of the quality control process.

In an embodiment, this image is retrieved by collecting and scanning printed media with scanning equipment 17. Alternatively, in another embodiment, pre-press files 202 (directly) used for preparing the printing plates in a computer-to-plate process could be sent by the publisher 20 to the system 1. In this alternative, no control of problems happening during the physical printing process itself is possible; however, the pre-press page corresponds closely to the printed page, so that at least all problems that are not directly related to the printing process itself are detectable (errors on layout, size, text or graphic content, colors, etc. . . . ).

The publication and quality control processes comprise a step of segmenting and extracting the electronic images 202 or 170, using a segmentation and extraction engine 4, to retrieve published items that should be controlled and for which tear sheets should be produced and sent.

A next step is to identify, for each extracted item, the corresponding publication order in the electronic database of orders. Once this item has been found, the corresponding specifications are retrieved, and the publication and quality control can be performed by confronting measurements of the extracted item (extracted metadata 12, 13) with the requested specifications 10, 11 in the database of orders 10, 11.

Even if only part of the specifications (down to a very minimal set of them) of an item are available in the database 10, 11, the system of the invention can help to extract the item from a printed media 201 and to measure metadata 13 in this item. The measured metadata 13 can then be used for statistical or retrieving purposes, or sent to another entity in charge of the publication and/or quality control process which can confront those metadata with ordered specifications in the database 10, 11.

It may happen that some items extracted by the system 1 from the printed media pages 201 do not correspond to specifications present in the database 10, 11. This may happen for example when an insertion has been ordered and managed by yet another third party. In this case, the system 1 may retrieve the identification of the advertising customer 2 from previously entered orders, and/or use the extracted data for statistical purposes.

The database 14 of previously extracted items can also be used for retrieving a published item (identified by a make, a brand name, etc.) in a set of printed media 201. In such a situation, the system 1 will find and extract the corresponding item and will send electronically to the client a report with the extracted version of the published item and its acquired measured data 12, 13.

In the prior art, as the quality control was mainly a manual, cost-intensive task, the publishers 20 usually controlled only (or had the control performed only for) printed advertisements. The automated quality control process of the invention allows the publishers 20 to also easily control (or have the control performed for) the quality of other types of published items, including editorial content, games/contest content, self-promotional content, classified advertisements, etc.

The quantified expression of quality (using various numerical indicators and comparisons based on different metadata items) will remove most of the subjectivity in quality analysis currently existing, potentially reduce the length and intensity and thus costs of bargains and conflicts leading to settlements, and provide an automatic way to compute the discount offered when errors are detected.

In a preferred embodiment, the entity in charge of the quality control is also in charge of the content acquisition (scanning process or importation of pre-press files) and runs the central system 1 including the centralized electronic database 10, 11 of orders. In another embodiment, the quality control and tear sheet service is performed over a Web site, or using email, ftp upload or other electronic transmission means. In this case, a scanned picture 170 of a printed media page 201 to be analyzed and controlled, or a pre-press full-page image 202, could be sent to the entity operating the system 1.

The centralization of the database 10, 11 improves the efficiency of the method in terms of speed and evolution. As the system 1 is shared among several advertising customers, several publishers and several printed media, it can learn and improve its ability to extract various metadata features from the published item. The system 1 will progress, for example, in the analysis of the layout of the different printed media, but also in the analysis of the layout of the items (i.e. specific to the advertiser for advertisements).

The invention allows to learn from this discovery and matching process and to create over time a knowledge database 14. This knowledge database is accumulated through the analysis of parts of item content (logos used, pictures, trademarks, characteristics of products, vendors, names of personality, etc,) and of administrative information (data on advertisers, advertisement campaigns realized, data on editors, etc.). The knowledge database preferably also contains a priori known reference layouts 140 of printed media useful to increase efficiency of the segmentation and extraction engine 4 and of the metadata extraction step.

This knowledge database 14 allows identifying items found in the pages but not stored in the database of orders 10, 11 by remembering/reutilizing what was learned, automatically or through human assistance, in previous extractions. For example, the system 1 can reuse metadata elements previously extracted from the same printed media, from the same advertiser, or from the same advertising campaign, and use this metadata to link the printed item to the right recipient and even to the right campaign of an advertiser. So, the system is conceived to learn more and more by analyzing the printed media. Each new detected and recognized part of content can be signaled to an operator that could easily validate or not the enrichment of the knowledge database 14 of the system 1.

The publication and quality control processes 5 allow to make sure that ordered items have actually been published, and that they have been correctly published in accordance with the specifications. A comparison of ordered specifications with the retrieved metadata is thus performed to detect publication errors and problems (step 90) and to control the integrity of the published content (step 91). So, for each extracted item, the system is able to:
identify or retrieve the name or designation of the printed media 201,
identify or retrieve the publication date,
identify the column, section and page number,
measure the topological location of the item on the page,
automatically measure the size and number of columns occupied by the item,
delineate the corresponding areas to extract a picture of it,
retrieve the matching publication order and the related specifications from the database of publication orders 10, 11,
identify the number and references of colors used, their characteristics being detailed in the retrieved specifications,
detect defaults or discrepancies of quality in colors (step 92), possibly in the CIELAB color space.

A true proof of publication 6 (a paper or electronic tear sheet) corresponding exactly to what has been published is automatically generated for each extracted item for which a corresponding order is found in the database 10, 11. This tear sheet includes an image corresponding to the extracted item, and preferably another image corresponding to the page of the printed media containing the concerned published item. It is accompanied by a quality report 93 prepared during step 92 and containing the measured indicators.

The system 1 uses identifying metadata 13 retrieved during steps 80 and 81 from the extracted items in the captured full pages 170, 202 (step 8) to create a link with the matching order in the database 10, 11. The addresses of the recipients to which the proof of publication, or a pointer to this proof, should be sent, as well as the specifications with which the extracted item should be compared, are automatically retrieved from the database 10, 11.

In an embodiment, the identifying metadata 13 are embedded in a watermark, using any form of watermarking scheme, that can be decoded from the digital image of the item. This embodiment works better if the published item 2020 includes an image, preferably a large-size/high-resolution image. Before the printing process, at least one image or logo in the item to publish is marked in an invisible manner with a watermark. The watermark preferably includes a unique identifier, for example a string of characters, numbers, or signs, coded or not, unequivocally identifying the printed item in the database 10, 11.

In another embodiment, the identifying metadata include a visible unique identifier, for example a barcode or a string of alphanumerical characters or signs inserted before publication in the text or in the picture of the item. This identifier can be retrieved from the extracted item using OCR and/or pattern matching techniques.

In another embodiment, the identifying metadata include metadata elements sent by the publisher 20 to the entity in charge of the quality control with the system 1. Those supplementary metadata elements, which can be entered manually by the publisher, may include for example the position of each item 2020 in the printed media, the page number, etc.

Different approaches can be used for identifying an item that has not been marked with an unequivocal identifier. An “intelligent” multi-level matching approach could be used to identify in the image of a retrieved printed media page 201 the different items among all the known items 2020 supposed to be printed in the analyzed printed media. This approach requires that a set of specification elements sufficient for identifying each item 2020 is available in the database of orders. In this approach, metadata of the retrieved image are acquired or processed, and compared to corresponding specification elements in the database of orders 10, 11. The metadata used can include for example the average level of colors or black pixels, dominant spatial frequencies or wavelet components, the text and graphic content of the item, the expected size, position, and so on.

If an image comparison process is not applicable for identifying the published item 2020, optical character recognition techniques and/or pattern recognition algorithms combined with segmentation methods can be used for analyzing and indexing the content of this item. In the case of advertisements, the category, name, model, make, price, etc. of the advertised product, as well as the name or brand of the advertising company, can be automatically retrieved. Other layout elements like logos and pictures can also be extracted and indexed. A specific signature of a logo (invariants calculated by processing the logo image), independent of the size, resolution or other geometrical transformation, are other useful identifying metadata.

In a preferred embodiment, a similar indexing process is performed on the orders in the database 10, 11, for delivering specifications stored with the original item in the database of orders 10, 11. The data delivered by the indexing process are preferably structured in a format using a known standard data and/or layout description and tagging language, such as XML (extended Markup Language), and linked in the database with the associated item.

So, when the published items have been extracted and indexed, the matching with the corresponding specifications in the database can be done more easily.

We will now describe in more detail the publication and quality control processes.

As described on the FIGS. 1, 2 and 3, the global system of automatic publication control and printing quality control performs the following steps:

Storage and Marking (When Possible and/or Necessary) of the Original Content

During this step, advertising customers 2 send publication orders and associated specifications directly to the entity in charge of the quality control, or to a publisher or intermediary that will relay it to this entity.

A central electronic database 10, 11 in the system 1 receives publication orders from different customers 2 and for different publishers 20 and stores the content 10, associated metadata 11 (specifications) as well as data indexed or computed from those metadata. Items to be published are preferably marked with an embedded watermark or with a unique visible identifier computed by a watermarking software and/or hardware engine 15 in the system 1. The embedded identifier is also stored in the database of orders 10, 11 for a quick retrieval process. A different identifier is preferably used for each different publication of the same item 2020 in the same and/or in different printed media.

In the case of a watermarked item, the selected watermarking scheme has to make the mark invisible to the human eye but yet resistant to a process where the item to publish is watermarked in its digital form then printed and scanned. The watermark has to re-emerge from the scanned image 170 and from the pre-press image file 202. The watermark should also be robust to image processing operations that may be performed during the pre-press process, during the printing or during the scanning, including resizing, geometrical transformations, compression, enhancing, color conversions or color channel splitting and combining.

Colored images are usually printed using multiple image plates; the images are divided into color planes corresponding to the colors of ink used for the printing process. Each color is printed using a separate plate that prints that color. For example, an image may be separated into Cyan, Magenta, Yellow and Black (CMYK) color planes. The different plates must be precisely aligned during the printing process. Any misalignment of the plates will cause blurring in the image and may make it difficult or impossible to read a watermark that was embedded in the image. So, in order to avoid this problem, the watermarks could be inserted directly in one color plane only (preferably the color plane corresponding to the preponderant canonical color in the picture). However, as it is possible to include different watermarks in different areas of a picture, it will be possible to insert a watermark in the colored areas of a picture item in order to detect rapidly a misalignment of the plates. Indeed, plate misalignment could make it impossible to read watermarks in the colored areas.

The original content 10 of each publication order is preferably indexed before publication, using an indexation hardware and/or software engine 16.

The preferably marked items are then sent to the publisher 20 for publication in the selected printed media 201.

Capture, Segmentation, Extraction and Identification of Published Items

The entity operating the system 1 that controls the publication and the quality of publication of the printed items preferably performs the following steps:
a) Retrieving an electronic file corresponding to each page of the printed media 201 (step 8). In an embodiment, this is performed by scanning the printed media pages 201 using full-size high-quality scanners 17. In another embodiment, electronic pre-press versions 202 of the printed media pages are delivered directly by the publisher 20.
b) Storing each page as a unique electronic file 202 or 170 (in picture format).
c) Automatic detection of watermarks or other unique identifiers in the retrieved image files 170 or 202 (step 80). Even if not all items have been marked, the detection of identifiers accelerates subsequent steps.
d) For each detected identifier, query of the database of orders 10, 11 for retrieving the original metadata, i.e. specifications and identifiers of the ordered item (step 81). The specifications can be used for determining if the detected area corresponds to a logo in a text item, or to a complete picture. If the area corresponds to a logo, the layout of the item is analyzed in order to zone and segment its borders (steps 80 and 81).
e) Processing and analysis of the full-page pictures in order to detect other published items in non-marked areas. Human-eyes-like recognition of the layout of the page is performed by zoning and segmenting of the different items in each page. Zoning is obtained by detecting columns, lines surrounding the different areas, title bars announcing for example advertisements, by detecting homogeneous areas identified by similar colors, background or any other graphical feature, etc. The process could be enhanced by using the reference layouts 140 (graphics information) and/or graphical design elements (fonts, colors, etc.) of each printed media provided by the publisher (supervised segmentation). Then OCR techniques, using an OCR hardware and/or software engine 40, or pattern recognition could be used additionally to detect and analyze specific areas (in particular advertisement areas) among the segmented areas (detection of strings of words or pictures indicating, for example, an advertisement) and to identify the different sections and subsections of the printed media (for example advertisement headings and categories). The name or designation of the printed media and the page number should be identified by using recognition techniques (possibly OCR) in the header or the footer area of the page. Alternatively, an identification of the printed media could be introduced at the start of the acquisition (scanning or importing from the pre-press plate files) process by an operator manually entering the title, the date of publication, the number of sections and their name or designation, and the number of pages. The results of the segmentation and detection processes could be optionally displayed, if necessary, to a human operator who will then be able to make manual corrections.
f) Extracting from the picture of each page all the marked areas that correspond to the identified items, and all the other detected and segmented areas (step 81)
g) Measuring the size and position of the different detected items in the analyzed page. Metadata containing the measurements and position of each entity are created and stored, preferably for a temporary period. Each extracted area then yields an “extracted” picture 9 stored in a database 12 and related to its own metadata in another database 13. These extracted pictures and the corresponding electronic full page of printed media could be used, for example, to send an electronic tear sheet to the print advertisers as proof of publication and quality control.
h) Post-processing of all the extracted pictures in order to filter, if appropriate, the noise produced by the scanning process (step 82).
i) For each extracted marked picture, use of the unique identifier embedded in the detected mark to recover the corresponding specifications in the database of orders 10, 11, including the reference picture. If the specification does not contain a reference image, but only a text content and a layout or additional logo or picture, a reference picture corresponding to the specified layout is composed for facilitating the comparison with the extracted item (step 83).
j) For each extracted item that does not include a unique mark: identification and searching of the corresponding original item in the database of orders 10, 11, and retrieving of the corresponding specifications. This is realized by using first the above-described multi-level matching approach, i.e. by researching the “good” original candidates from the database of orders by matching metadata of the extracted item with specifications in the database. Then, if some extracted items were not unambiguously identified by the preceding methods, recognition of the text and its font in each extracted item using optical character recognition methods and spell checking, and storage of the full text content of the extracted item in the database 12. Finally, if some extracted items are still not identified, analysis and recognition of the layout of each unidentified extracted item (position of text and logo, surroundings, etc.) in order to extract further metadata by a semantic and/or pragmatic analysis of the segmented areas. The extracted identifying metadata could include logos or images extracted from the image using any method of logo or image extraction and matching with corresponding images or logos in a database of logos and images, for example by computing invariant measures using image processing or research of similarities by adaptive pattern recognition. The full text of the extracted item can also be indexed and categorized in order to create supplementary metadata for matching with the specifications of the different publication orders in the database.
k) Retrieving the publication order in the database 10, 11 corresponding to the extracted item. This can be done by a method using a scalable multi-level search engine that takes into account the printed media name or designation and page number of the extracted advertisement if detected, the measured size and position, the logo if detected and the more pertinent measured metadata of indexing (such as phone number, price, type, category, etc.). It is possible here that the system finds several candidates in the database of orders. This may be due to errors in the recognition process or in the publication process. If many candidates are found, the detection of the matching reference candidate is realized by computing the difference in the color domain (possibly CYMK) between the graphic content of the image specified in the order and the image of the extracted item. In the case of a published item that does not include a picture, the system composes for each candidate the reference picture corresponding to the specified layout and to the specified text and/or graphic part. This composition could also be realized before the order is sent to the editor. The recomposed image could be stored in the database of orders.
l) Control of publication and control of printing quality

This process preferably involves the following steps:
a) Detection of errors in the publication process during step 90, by confronting the measured and detected metadata 12, 13 with the specifications of the items in the database of orders 10, 11. The specifications of the publication order in the database of orders 10, 11 can then be replaced and/or updated by the corresponding measured and extracted metadata 12, 13.
b) Computation of the difference between the extracted picture 9 and the reference picture specified in the publication order 12, with adaptation of the size and resolution of the reference picture if necessary, in order to compare the reference picture with the extracted picture (step 91). Each picture is preferably decomposed in color planes depending on the chosen optimal color space. Then the color difference between the extracted and reference pictures is computed, for example by computing the root mean square error or the mean absolute deviation, in the different color planes of both pictures. It allows control of the quality of the printed version in terms of content integrity, i.e. correctness of the published item as compared to the order (presence of all the text, logo and/or photograph parts in the correct position, computation of the number of colors). The computed differences are then compared to predefined error thresholds in order to decide if the quality of the printed material is suitable or not.
c) Color quality control (step 92). This control makes more sense if the extracted electronic image file is extracted by scanning the printed image, but is somehow also useful if the image is retrieved from a pre-press file.

The color space of the reference picture is adapted to that of the extracted picture by a ripping process. Effectively, the printing device used during the publication has a limited color space, i.e. a limited color range that it can reproduce with high fidelity. So, generally, the color space of the original is reduced during the creation or the pre-press processes.

Once all the adaptations have been made (size, resolution, color range), each picture is decomposed in an independent device color space reflecting the human visual perception of colors, such as for example the known CIELAB color space. Then the color difference between the extracted and the reference pictures is calculated. The obtained differences are then compared to predefined error thresholds in order to decide if the quality of the printed material is suitable or not.
d) If a default in the quality of the published item is detected, an electronic error report is generated automatically during step 93 and possibly sent to the supervisor of the system 1 for human confirmation. If there is no default, a publication validation report is generated automatically and made available for delivery to the customer 2, supervisor or any interested and allowed party.
e) In the case where the published item is an advertisement, the report generated in the preceding step 93 can optionally be sent automatically to an administrative system with an electronic tear sheet including the extracted item and the extracted version of the page. The report and the captured and extracted pictures can also be sent to a human operator in order to validate the process before being sent to the administrative system.

Finally, a notification can also be sent to an automatic or semi-automatic system to issue an electronic or paper tear sheet that is sent to the recipients together with a report and with the invoice for the publication. A discount can be computed automatically when errors have been detected.
f) In some circumstances, an extracted published item does not correspond to any order in the database 10, 11. This can occur in the following cases:
The order corresponding to the item is not in the database of orders 10, 11 because the entity in charge of the quality control has no access to all the content published in the media or because the order has been entered or transferred into the database only after the publication of the item. In the first case, a report could be sent to the publisher 20, to the advertiser 2 or to the advertising agency (if this one can be identified) to inform them that some content has been identified and extracted from the printed media. This party may then send specifications of the order available in their own system and request the entity to compare automatically those specifications with the metadata of the extracted item. In the second case, the quality control should be postponed until the order has been entered in the database of orders.
It may also be the case that the process of analysis, recognition and indexing of the extracted advertisement has failed. Errors may be due to the optical character recognition part, to an altered watermark, to a failed logo recognition process, etc. If there is any doubt on the order corresponding to an extracted item, the system sends the results of the analysis (extraction and indexing) and possibly a list of potential matching orders to a human operator in order to validate or correct the identification process.

The database of knowledge 14 preferably includes logos, pictures, trademarks, names and characteristics of commonly advertised products and services, advertisers, etc. The system preferably adapts itself and completes this database each time a new element has been recognized. It improves data and algorithms from all its activities via a feedback loop that stores in the system itself all knowledge acquired during the recurring operational activities.

The centralization of ordered and retrieved metadata (specifications) from different items and different printed media in a database allows for new value-added services to be offered, based for example on indexing of content with a content indexation engine 16, statistical analysis, market analysis, etc. It is also possible to provide access to specific modules of the system, such as the item extraction part or the OCR (Optical Character Recognition) engine 40. Finally, the extracted content can be distributed and reused over different channels (email, Internet, mobile telecommunications, etc.) for consultation by readers or any interested party, publication proofing, alerting, etc., these processes being possible and efficient thanks to content indexing.

The statistical analyses of published items performed by the system 1 may concern:
the advertising content of display and classified advertisements. Statistics may concern for example the makes, products, companies or agencies featured on a plurality of printed media, and may be useful to understand the advertising strategy of advertisers in order to offer business intelligence services, or to analyze the competition (alerts on campaigns, pricing strategy, commercial tendencies, graphical and marketing trends, etc.);
container: statistics and information on the advertisement formats used by the advertisers 2 and by competitors, types of media preferred by the different advertisers, recurrence and frequency of their campaigns in those media;
quality of content: progressive analysis of the quality drifts in colors, spelling and publication in general by printed media, printing center or publisher or advertiser, quality comparison between various media;
budget: combining the detected advertisements and the price list of printed media allows to get an evaluation of the media-mix strategy of an advertiser 2 as well as its global advertising budget or budget for specific campaigns. From a publisher standpoint, it allows to get an evaluation of advertising revenues of competitors.

The system could also be used to analyze and index the editorial part of a printed media in order to provide, for example, clipping services by Web or email or all other electronic means with an intelligent search service (by words or phrases) of news or articles or advertisements from printed media (for example, all the advertisements about a specific car or all news about a given subject).

1. A method for preparing automated proof of publications, said method comprising:
retrieving an electronic file corresponding to the printed media pages including the published items,
automatically extracting from said electronic file identifying metadata characterizing said published items,
using said identifying metadata to retrieve from a database the address of predefined recipients to which said proof of publication should be sent,
sending a proof of publication including at least the portion of said page including said published item to said recipients.

2. The method of claim 1, wherein said electronic file is retrieved by scanning said printed media pages.

3. The method of claim 1, wherein said electronic file is a digital image of a pre-press plate corresponding to said printed media page.

4. The method of claim 2, further comprising a step of joining to said proof of publication an automatically processed and generated quality control report concerning the published item.

5. The method of claim 1, wherein said identifying metadata include a unique identifier unequivocally identifying said published item.

6. The method of claim 1, wherein at least part of said identifying metadata are embedded in a digital watermark in said published item.

7. The method of claim 1, wherein at least part of said identifying metadata are embedded in a visible code included in said published item.

8. The method of claim 1, wherein at least part of said identifying metadata are extracted from the text content of said published item using a process of image analysis and/or an optical character recognition process.

9. The method of claim 1, wherein said identifying metadata comprise the position and size of said published item.

10. The method of claim 1, wherein said identifying metadata include the text and/or graphic content of said published item.

11. The method of claim 1, wherein said identifying metadata include the title or designation of said printed media, the number of said page, the section of said printed media to which said page belongs and/or the publication date.

12. (canceled)

13. The method of claim 1, wherein known reference layouts of said printed media are used to improve the retrieving of said identifying metadata.

14. The method of claim 1, further comprising a step of automatically segmenting said pages into a plurality of published items.

15. The method of claim 14, wherein at least a partial result of the segmenting step and at least a part of the extracted identifying metadata coupled with their respective items are displayed to a human operator in order to allow for a manual correction and/or validation.

16. The method of claim 1, further comprising a quality control step for automatically controlling the quality of said published item.

17. The method of claim 16, wherein said quality control step comprises a step of confronting said published item with predefined specifications.

18. The method of claim 16, further comprising a step of automatically determining a settlement method when quality problems are detected.

19. The method of claim 1, wherein said automatic extraction and/or identification steps are performed using knowledge gained from previously extracted and/or identified items.

20. The method of claim 1, further comprising a step of computing statistics on a plurality of extracted items.

21. The method of claim 1, further comprising a step of performing market analysis based on a plurality of extracted items.

22-24. (canceled)

25. A method for supervising the publication of items in printed media, said method comprising:
preparing a database including specifications for a plurality of items to publish,
publishing said items on printed media using said specifications,
retrieving an electronic file corresponding to the printed media pages including the published items,
performing a quality control for controlling the quality of said published items,
wherein said quality control is performed by confronting the items in said electronic file with said specifications.

26. The method of claim 25, wherein said electronic file is retrieved by scanning said printed media pages.

27. The method of claim 25, wherein said electronic file is a pre-press plate corresponding to said printed media page.

28. The method of claim 26, further comprising a step of automatically computing a settlement method when quality problems are detected.

29. The method of claim 25, wherein said quality control comprises a step of automatically determining the size and position of said published item in said printed media and comparing said size and position with said specifications.

30. The method of claim 25, wherein said quality control comprises a step of automatically verifying the colors in said published item.

31. The method of claim 25, wherein said quality control comprises a step of automatically computing the differences between the extracted image and a reference image included in said specifications.

32. The method of claim 31, wherein said reference image is a version digitally simulating biases and deformations, such as color transformations, ink and paper quality imperfections, etc., introduced by the printing process.

33. The method of claim 25, wherein said quality control comprises a step of automatically comparing the publication date with a date given in said specifications.

34. The method of claim 25, wherein said quality control comprises a step of automatically extracting the text content and/or the graphic content from said published item, and automatically comparing said text content and/or graphic content with a text content and/or graphic content included in said specifications.

35. The method of claim 25, further comprising:
automatically extracting from the pages identifying metadata characterizing said published items,
using said identifying metadata to retrieve from said database the specifications of each published item.

36-45. (canceled)

46. The method of claim 25, wherein at least part of said specifications are retrieved before said quality control from a server different than the one used for said quality control.

47. The method of claim 25, further comprising a step of computing statistics or market analysis using data from extracted items.

48-49. (canceled)

50. A computer medium having software data for performing the method of claim 1.

51. A method for supervising the publication of items imprinted media, said method comprising:
retrieving an electronic file corresponding to the printed media pages including the published items,
segmenting said pages into a plurality of published items,
extracting identifying metadata characterizing each said published item, and
retrieving from a database the address of predefined recipients to which proof of publications and/or results of quality control checks should be sent.
